(19) United States
(12) Patent Application Publication
(10) Pub. No.: US 2005/0275665 A1
(43) Pub. Date: Dec. 15, 2005

(54) System and method for efficiently supporting image rotation modes by utilizing a display controller

(76) Inventor: Keith Kejser, New Westminster (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/971,808

(22) Filed: Oct. 22, 2004

Related U.S. Application Data
(60) Provisional application No. 60/579,392, filed on Jun. 14, 2004.

(51) Int. Cl. G09G 5/00

(52) U.S. Cl. 345/649

(57) ABSTRACT

A system and method are disclosed for efficiently supporting image rotation modes by using a display controller that includes a controller interface, a memory array of memory cells, and controller logic. The controller interface receives image data from an image data source, and responsively generates one or more memory addresses for storing the image data. The memory array of memory cells is configured for storing the image data in a distributed manner to facilitate read operations in one or more rotation modes. The controller logic generates read addresses to access a rotation sequence of pixels from the image data depending upon a selectable rotation mode parameter. The controller logic then provides the rotation sequence of pixels from the image data to a display device for viewing in a correct orientation depending upon a rotation mode corresponding to the selectable rotation mode parameter.

This application claims the benefit of the provisional application Ser. No. 60/579,392 filed Jun. 14, 2004, entitled High Speed Method To Read A Rotated Image From Memory, which is incorporated by reference in its entirety.

### 1. FIELD OF INVENTION

This invention relates generally to electronic display controller systems, and relates more particularly to a system and method for efficiently supporting image rotation modes by utilizing a display controller.

### 2. DESCRIPTION OF THE BACKGROUND ART

Implementing efficient methods for displaying electronic image data is a significant consideration for designers and manufacturers of contemporary electronic devices. However, efficiently displaying image data with electronic devices may create substantial challenges for system designers. For example, enhanced demands for increased device functionality and performance may require more system operating power and require additional hardware resources. An increase in power or hardware requirements may also result in a corresponding detrimental economic impact due to increased production costs and operational inefficiencies.

Furthermore, enhanced device capability to perform various advanced display control operations may provide additional benefits to a system user, but may also place increased demands on the control and management of various device components. For example, an enhanced electronic device that efficiently manipulates, transfers, and displays digital image data may benefit from an efficient implementation because of the large amount and complexity of the digital data involved.

Due to growing demands on system resources and substantially increasing data magnitudes, it is apparent that developing new techniques for controlling the display of electronic image data is a matter of concern for related electronic technologies. Therefore, for all the foregoing reasons, developing efficient systems for displaying electronic image data remains a significant consideration for designers, manufacturers, and users of contemporary electronic devices.

### SUMMARY

In accordance with the present invention, a system and method are disclosed for efficiently supporting image rotation modes by utilizing a display controller. In certain embodiments, an electronic device may be implemented to include a central-processing unit (CPU), a display, and the display controller. In certain embodiments, the CPU initially programs various controller parameters for the display controller. For example, the CPU may program controller registers to specific a display line width and a color depth value.

During a write operation, the CPU initially provides a user address to a controller interface of display controller. Then, the CPU transmits image data for the write operation to the controller interface. In response, the controller interface generates memory addresses and chip select signals for storing the received image data into a parallel bank of memory cells. The controller interface then sends the image data to the memory cells, and the memory cells store the received image data to conclude the write operation.

Prior to performing a read operation, the CPU selects a rotation mode for displaying image data on the display. Then, controller logic of the display controller generates read addresses to access stored image data in the memory cells depending upon the selected rotation mode. The memory cells provide the addressed image data to the controller logic in the correct specified rotation sequence. The controller logic then transmits the image data to the display which presents the received image data for viewing by a system user in the correct designated rotation. For at least the foregoing reasons, the present invention therefore provides an improved system and method efficiently supporting image rotation modes by utilizing a display controller.

### BRIEF DESCRIPTION OF THE DRAWINGS

FIG. 1 is a block diagram for one embodiment of an electronic device, in accordance with the present invention;

FIG. 2 is a block diagram for one embodiment of the display controller of FIG. 1, in accordance with the present invention;

FIG. 3 is a diagram for one embodiment of the memory cells of FIG. 2, in accordance with the present invention;

FIG. 4 is a diagram for one embodiment of a zero-degree rotation mode, in accordance with the present invention;

FIG. 5 is a diagram for one embodiment of a 90-degree rotation mode, in accordance with the present invention;

FIG. 6 is a diagram for one embodiment of a 180-degree rotation mode, in accordance with the present invention;

FIG. 7 is a diagram for one embodiment of a 270-degree rotation mode, in accordance with the present invention;

FIG. 8 is a flowchart of method steps for performing a write operation, in accordance with one embodiment of the present invention; and

FIG. 9 is a flowchart of method steps for performing a read operation, in accordance with one embodiment of the present invention.

### DETAILED DESCRIPTION

The present invention relates to an improvement in display controller systems. The following description is presented to enable one of ordinary skill in the art to make and use the invention, and is provided in the context of a patent application and its requirements. Various modifications to the embodiments disclosed herein will be apparent to those skilled in the art, and the generic principles herein may be applied to other embodiments. Thus, the present invention is not intended to be limited to the embodiments shown, but is to be accorded the widest scope consistent with the principles and features described herein.

The present invention comprises a system and method for efficiently supporting image rotation modes by using a display controller that includes a controller interface, a memory array of memory cells, and controller logic. The controller interface receives image data from an image data source, and responsively generates one or more memory addresses for storing the image data. The memory array of memory cells is configured for storing the image data in a distributed manner to facilitate read operations in one or more rotation modes. The controller logic generates read addresses to access a rotation sequence of pixels from the image data depending upon a selectable rotation mode parameter. The controller logic then provides the rotation sequence of pixels from the image data to a display device for viewing in a correct orientation depending upon a rotation mode corresponding to the selectable rotation mode parameter.

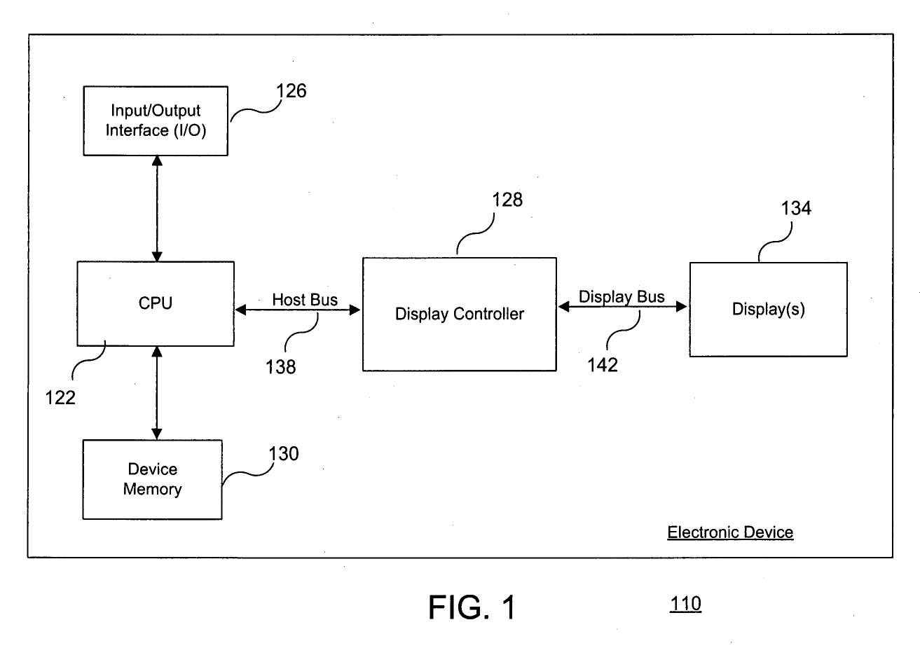

Referring now to FIG. 1, a block diagram for one embodiment of an electronic device 110 is shown, according to the present invention. The FIG. 1 embodiment includes, but is not limited to, a central processing unit (CPU) 122, an input/output interface (I/O) 126, a display controller 128, a device memory 130, and one or more display(s) 134. In alternate embodiments, electronic device 110 may include elements or functionalities in addition to, or instead of, certain of the elements or functionalities discussed in conjunction with the FIG. 1 embodiment.

In the FIG. 1 embodiment, CPU 122 may be implemented as any appropriate and effective processor device or microprocessor to thereby control and coordinate the operation of electronic device 110 in response to various software program instructions. In the FIG. 1 embodiment, device memory 130 may comprise any desired storage-device configurations, including, but not limited to, random access memory (RAM), read-only memory (ROM), and storage devices such as removable memory or hard disk drives. In the FIG. 1 embodiment, device memory 130 may include, but is not limited to, a device application of program instructions that are executed by CPU 122 to perform various functions and operations for electronic device 110. The particular nature and functionality of the device application typically varies depending upon factors such as the type and specific use of the corresponding electronic device 110.

In the FIG. 1 embodiment, the foregoing device application may include program instructions for allowing CPU 122 to provide image data and corresponding transfer and display information via host bus 138 to display controller 128. In accordance with the present invention, display controller 128 then responsively provides the received image data via display bus 142 to at least one of the display(s) 134 of electronic device 110. In the FIG. 1 embodiment, input/output interface (I/O) 126 may include one or more interfaces to receive and/or transmit any required types of information to or from electronic device 110. Input/output interface 126 may include one or more means for allowing a device user to communicate with electronic device 110. In addition, various external electronic devices may communicate with electronic device 110 through I/O 126. For example, a digital imaging device, such as a digital camera, may utilize input/output interface 126 to provide captured image data to electronic device 110.

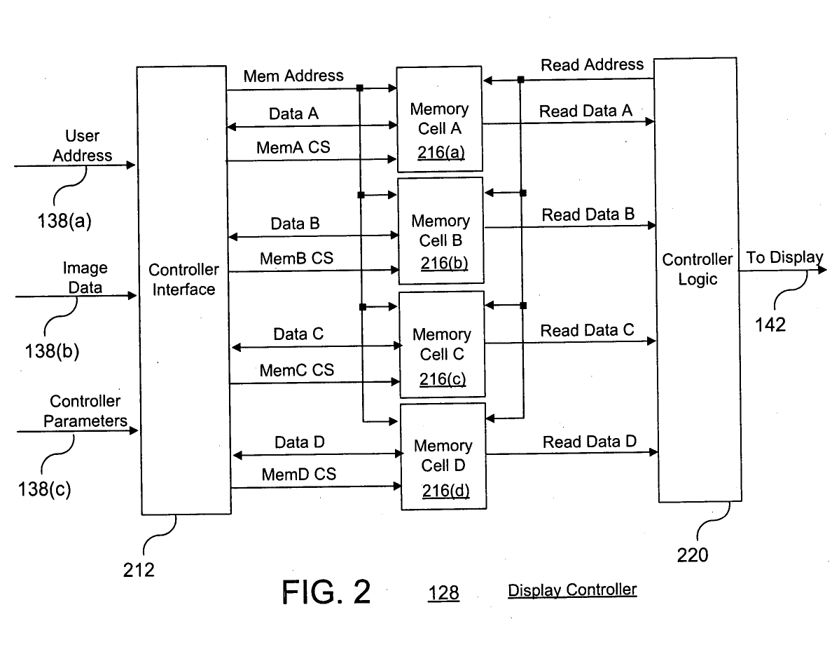

In the FIG. 1 embodiment, electronic device 110 may advantageously utilize display controller 128 for efficiently managing various operations and functionalities relating to display(s) 134. The implementation and functionality of display controller 128 is further discussed below in conjunction with FIGS. 2-9. In the FIG. 1 embodiment, electronic device 110 may be implemented as any desired type of electronic device or system. For example, in certain embodiments, electronic device 110 may alternately be implemented as a cellular telephone, a personal digital assistant device, an electronic imaging device, or a computer device. Various embodiments for the operation and utilization of electronic device 110 are further discussed below in conjunction with FIGS. 2-9.

Referring now to FIG. 2, a block diagram for one embodiment of the FIG. 1 display controller 128 is shown, according to the present invention. The FIG. 2 embodiment includes, but is not limited to, a controller interface 212, memory cells 216 (216(a), 216(b), 216(c), and 216(d)), and controller logic 220. In alternate embodiments, display controller 128 may include elements or functionalities in addition to, or instead of, certain of the elements or functionalities discussed in conjunction with the FIG. 2 embodiment.

In the FIG. 2 embodiment, display controller 128 may be implemented as an integrated circuit device that accepts image data and corresponding transfer and display information from CPU 122 (FIG. 1). Display controller 128 then automatically provides the received image data to display 134 of electronic device 110 in an appropriate and efficient manner for displaying to a device user. In accordance with the present invention, display controller 128 supports various rotation modes for displaying image data upon display 134.

In the FIG. 2 embodiment, during a write operation, CPU 122 programs control registers in display controller 128 with various controller parameters. For example, CPU 122 may program a display line width value via path 138(c) to define how many bytes are in each display line of image data. CPU 122 may also program a color depth value to specify how may bits are utilized to represent each pixel in the image data. CPU 122 may then send a user address via path 138(a) to controller interface 212 for indicating which pixels in the display image data are to be rewritten by the write operation. CPU 122 then provides the image data for the write operation to controller interface 212 via path 138(b).

In the FIG. 2 embodiment, controller interface 212 then generates one or more appropriate memory addresses (Mem Address) to map the received image data into the correct location(s) in the memory cell array of memory cells 216. Controller interface 212 also generates corresponding memory chip select signals (MemA CS, MemB CS, MemC CS, and MemD CS) to enable one or more of memory cells A-D (216(a-d)) for the write operation. Controller interface 212 may then provide the received image data via one or more write data paths (Data A, Data B, Data C, and Data D) to designated ones of memory cells 216. Memory cells 216 may therefore store the received image data in a distributed manner to facilitate read operations for various rotation modes.

In the FIG. 2 embodiment, prior to a read operation, CPU 122 may select a rotation mode to specify the sequence in which controller logic 220 reads the stored image data from memory cells 216 for providing to display 134. Display 134 typically displays image data received from display controller 128 as if in a zero-degree rotation mode. Therefore controller logic 220 must alter the read sequence of pixels from memory cells 216 so that display 134 presents the image data in the selected rotation mode.

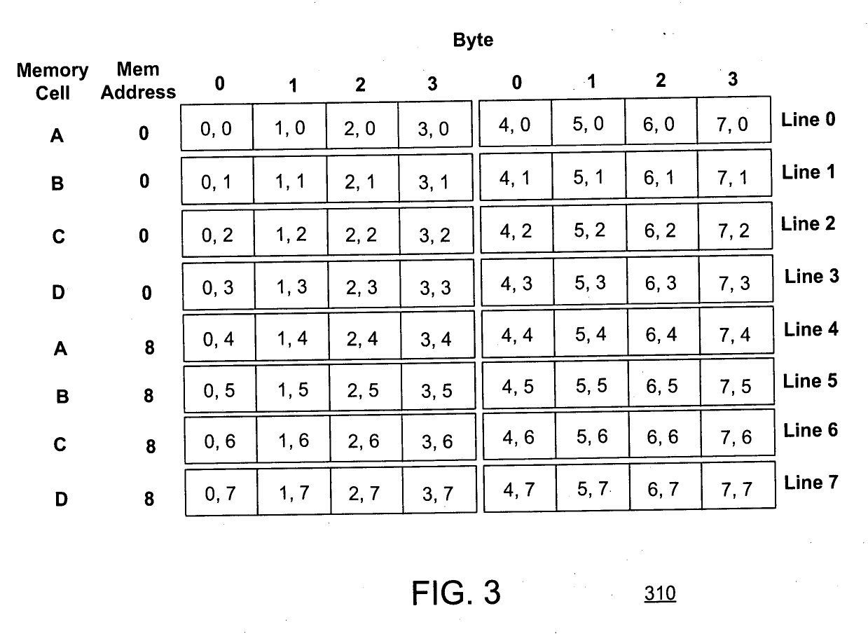

Depending upon the rotation mode selected for the read operation, controller logic 220 generates appropriate read addresses to memory cells 216 for accessing the correct sequence of pixels to provide to display 134. Controller logic 220 may then access the appropriate pixels of read data (Read Data A, Read Data B, Read Data C, and Read Data D) from memory cells 216 for providing to display 134 via path 142. In the FIG. 2 embodiment, memory cells 216 are arranged in a parallel bank of four memory cells 216(a-d). In certain rotation modes, controller logic 220 may more efficiently perform read operations since read data is accessed from four different cells simultaneously. In contrast, image rotation operations read from a single conventional contiguous memory may require four times as many read operations to obtain the same number of pixels as provided by the FIG. 2 embodiment. The operation of display controller 128 is further discussed below in conjunction with FIGS. 3-9.

Referring now to FIG. 3, a diagram 310 for one embodiment of the FIG. 2 memory cells 216 is shown, in accordance with the present invention. The FIG. 3 embodiment is presented for purposes of illustration, and in alternate embodiments, memory cells 216 may include contents and configurations in addition to, or instead of, certain of the contents and configurations discussed in conjunction with the FIG. 3 embodiment.

In the FIG. 3 embodiment, diagram 310 illustrates how pixels for an eight bit-per-pixel (8 bpp) image that is eight pixels wide by eight pixel high may be stored in memory cells 216 (FIG. 2). Therefore, for every 32-bit word in memory cells 216, there are four pixels in the 8 bpp format. In the FIG. 3 embodiment, and hereafter, each pixel is represented by an (x, y) coordinate representation in which the x-coordinate represents a vertical pixel column, and in which the y-coordinate represents a horizontal pixel line.

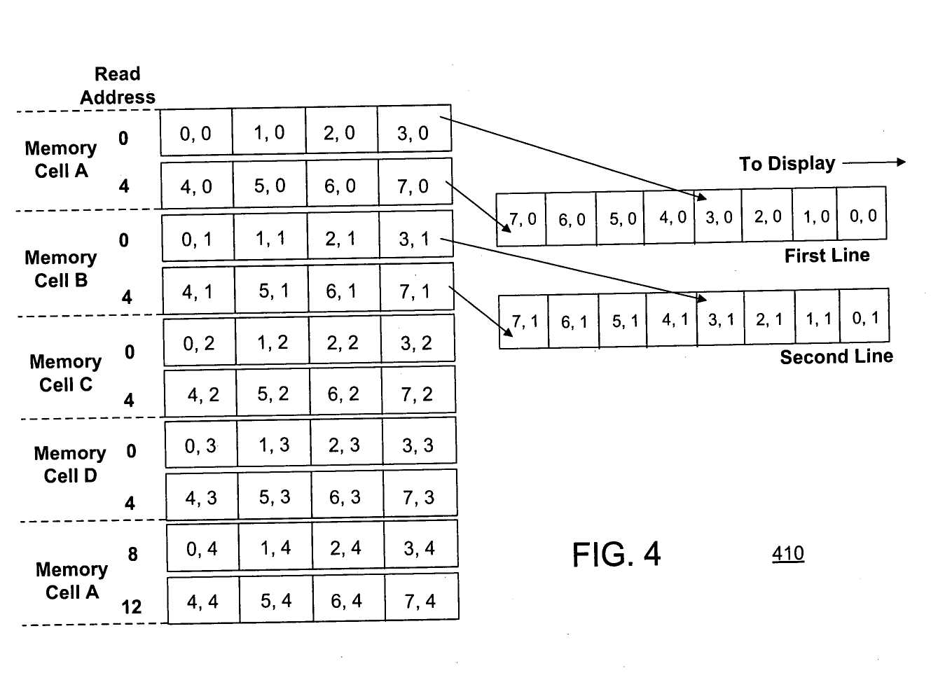

In the FIG. 3 embodiment, each sequential line of image data (lines 0-7) is stored in a different one of memory cells 216. For example, a line 0 (comprised of pixels (0, 0), (1, 0), (2, 0), (3, 0), (4, 0), (5, 0), (6, 0), and (7, 0)) is stored in memory cell A 216(a), a line 1 is stored in memory cell B 216(b), a line 2 is stored in memory cell C 216(c), and a line 3 is stored in memory cell D 216(d). When line 3 is written into final memory cell D 216(d), then the storage sequence employs a “wrap around” technique and repeats with lines 4-7 being stored into subsequent addresses in the same sequence of memory cells A-D 216. The exemplary pixels stored in memory cells 216 in the FIG. 3 example will be further utilized below in conjunction with the examples in FIGS. 4-7 to illustrate read operations for various rotation modes supported by display controller 128.

Referring now to FIG. 4, a diagram 410 for one embodiment of a zero-degree rotation mode is shown, in accordance with the present invention. In the FIG. 4 embodiment, a zero-degree rotation mode displays images without any rotation so that the top of the images point straight up on display 134. The FIG. 4 embodiment is presented for purposes of illustration, and in alternate embodiments, the present invention may perform rotation modes that include elements and functionalities in addition to, or instead of, certain of the elements and functionalities discussed in conjunction with the FIG. 4 zero embodiment.

In the FIG. 4 embodiment, the (x, y) pixel coordinates of diagram 410 correspond to those (x, y) pixel coordinates shown in the FIG. 3 exemplary diagram 310 of memory cells 216. In the FIG. 4 embodiment, display 134 (FIG. 1) displays image data received from display controller 128 in a standard zero-degree rotation display sequence regardless of which rotation mode has been selected. With reference back to the FIG. 3 embodiment, in a zero-degree rotation mode, controller logic 220 provides pixels to display 134 in display lines that are arranged in a zero-degree rotation sequence of horizontal rows from the FIG. 3 memory cells 216 starting with top left pixel (0, 0), and ending with the bottom right pixel (7, 7).

In the FIG. 4 embodiment, controller logic 220 may provide a first display line of display pixels from memory cell A 216(a) to display 134 in the following sequence: (0, 0), (1, 0), (2, 0), (3, 0), (4, 0), (5, 0), (6, 0), (7, 0). Controller logic 220 may then provide a second display line of display pixels from memory cell B 216(b) to display 134 in the following sequence: (0, 1), (1, 1), (2, 1), (3, 1), (4, 1), (5, 1), (6, 1), (7, 1). Controller logic 220 may then continue to sequentially provide the remaining display lines of display pixels from memory cells 216 to display 134 in accordance with the same zero-degree rotation sequence shown in the FIG. 4 embodiment.

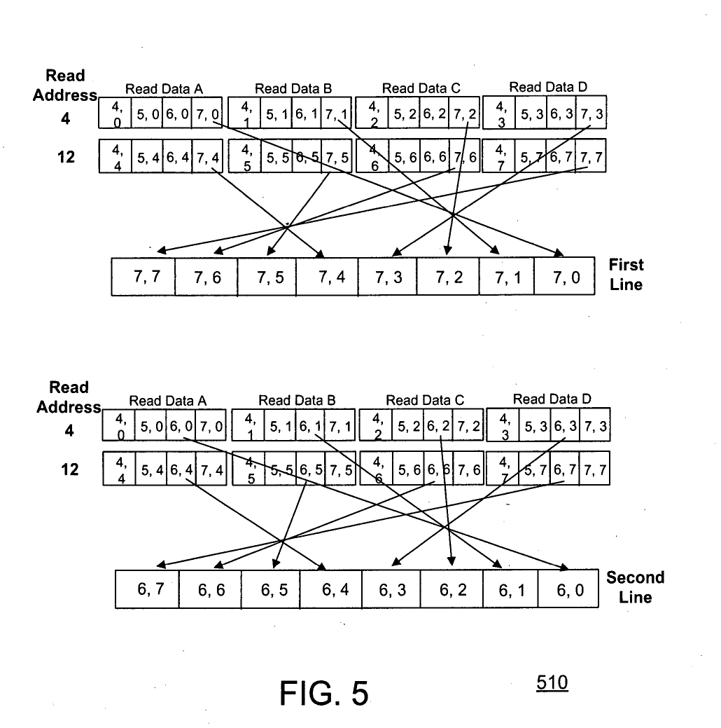

Referring now to FIG. 5, a diagram 510 for one embodiment of a 90-degree rotation mode is shown, in accordance with the present invention. In the FIG. 5 embodiment, a 90-degree rotation mode displays images rotated 90 degrees in a counterclockwise direction on display 134. The FIG. 5 embodiment is presented for purposes of illustration, and in alternate embodiments, the present invention may perform rotation modes that include elements and functionalities in addition to, or instead of, certain of the elements and functionalities discussed in conjunction with the FIG. 5 embodiment.

In the FIG. 5 embodiment, the (x, y) pixel coordinates of diagram 510 correspond to those (x, y) pixel coordinates shown in the FIG. 3 exemplary diagram 310 of memory cells 216. In the FIG. 5 embodiment, display 134 (FIG. 1) displays image data received from display controller 128 in a standard zero-degree rotation display sequence regardless of which rotation mode has been selected. With reference back to the FIG. 3 embodiment, in a 90-degree rotation mode, controller logic 220 provides pixels to display 134 in display lines that are arranged in a 90-degree rotation sequence of vertical columns from the FIG. 3 memory cells 216 starting with top right pixel (7, 0), and ending with the bottom left pixel (0, 7).

In the FIG. 5 embodiment, controller logic 220 may provide a first display line of display pixels from memory cells A-D 216(a-d) to display 134 in the following sequence: (7, 0), (7, 1), (7, 2), (7, 3), (7, 4), (7, 5), (7, 6), (7, 7). Controller logic 220 may then provide a second display line of display pixels from memory cell A-D 216(a-d) to display 134 in the following sequence: (6, 0), (6, 1), (6, 2), (6, 3), (6, 4), (6, 5), (6, 6), (6, 7). Controller logic 220 may then continue to sequentially provide the remaining display lines of display pixels from memory cells 216 to display 134 in accordance with the same 90-degree rotation sequence shown in the FIG. 5 embodiment. In accordance with the present invention, since memory cells 216 are arranged in a parallel bank configuration, controller logic 220 may efficiently perform read operations during the 90-degree rotation mode by simultaneously reading four sequential pixels for the 90-degree rotation display lines from different sequential memory cells A-D 216(a-d) (see FIG. 2).

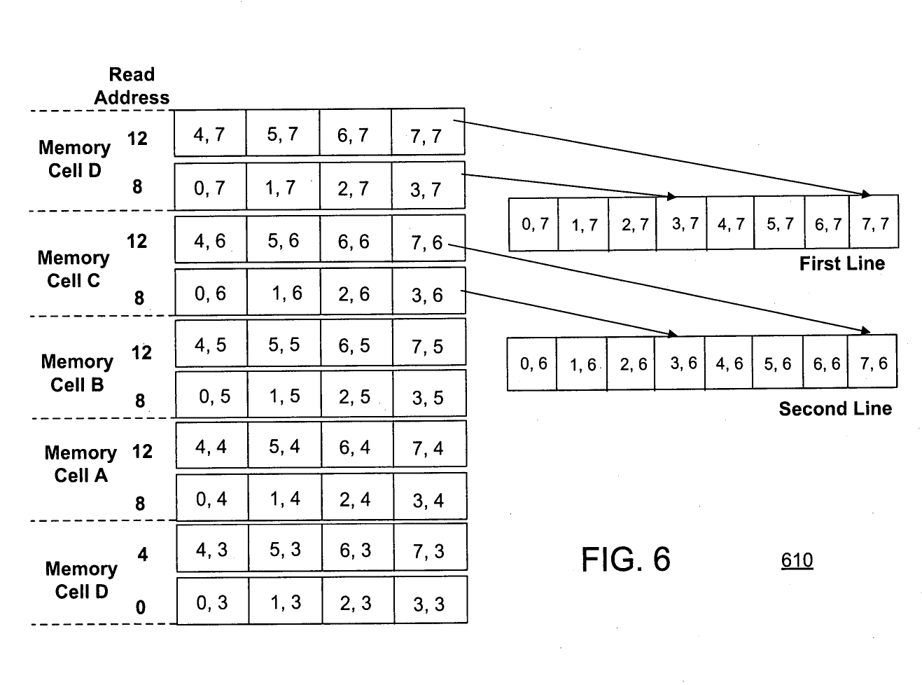

Referring now to FIG. 6, a diagram 610 for one embodiment of a 180-degree rotation mode is shown, in accordance with the present invention. In the FIG. 6 embodiment, a 180-degree rotation mode displays images rotated 180 degrees (upside down) on display 134. The FIG. 6 embodiment is presented for purposes of illustration, and in alternate embodiments, the present invention may perform rotation modes that include elements and functionalities in addition to, or instead of, certain of the elements and functionalities discussed in conjunction with the FIG. 6 embodiment.

In the FIG. 6 embodiment, the (x, y) pixel coordinates of diagram 610 correspond to those (x, y) pixel coordinates shown in the FIG. 3 exemplary diagram 310 of memory cells 216. In the FIG. 6 embodiment, display 134 (FIG. 1) displays image data received from display controller 128 in a standard zero-degree rotation display sequence regardless of which rotation mode has been selected. With reference back to the FIG. 3 embodiment, in a 180-degree rotation mode, controller logic 220 provides pixels to display 134 in display lines that are arranged in a 180-degree rotation sequence of horizontal rows from the FIG. 3 memory cells 216 starting with bottom right pixel (7, 7), and ending with the top left pixel (0, 0). The 180-degree rotation sequence therefore is essentially the reverse of the zero-degree rotation sequence discussed above in conjunction with FIG. 4.

In the FIG. 6 embodiment, controller logic 220 may provide a first display line of display pixels from memory cell D 216(d) to display 134 in the following sequence: (7, 7), (6, 7), (5, 7), (4, 7), (3, 7), (2, 7), (1, 7), 0, 7). Controller logic 220 may then provide a second display line of display pixels from memory cell C 216(c) to display 134 in the following sequence: (7, 6), (6, 6), (5, 6), (4, 6), (3, 6), (2, 6), (1, 6), (0, 6). Controller logic 220 may then continue to sequentially provide the remaining display lines of display pixels from memory cells 216 to display 134 in accordance with the same 180-degree rotation sequence shown in the FIG. 6 embodiment.

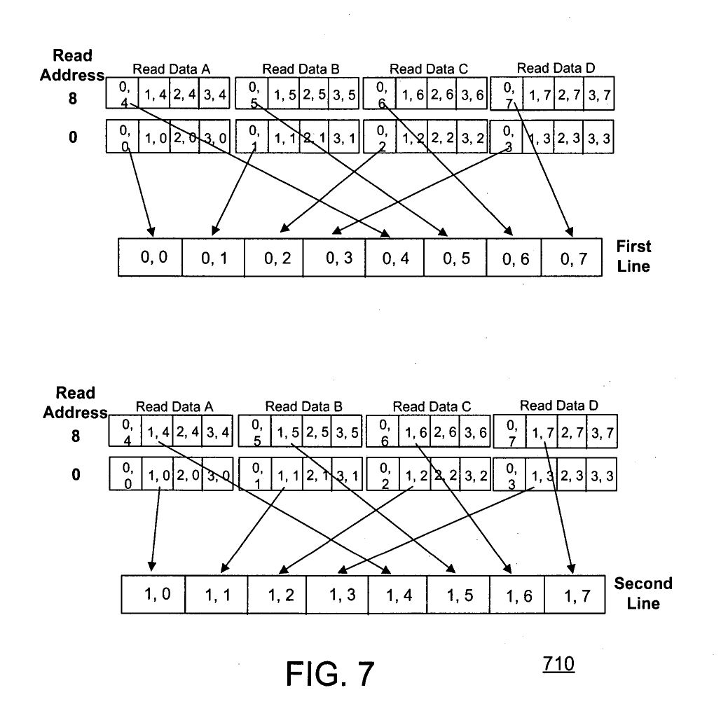

Referring now to FIG. 7, a diagram 710 for one embodiment of a 270-degree rotation mode is shown, in accordance with the present invention. In the FIG. 7 embodiment, a 270-degree rotation mode displays images rotated 270 degrees in a counterclockwise direction on display 134. The FIG. 7 embodiment is presented for purposes of illustration, and in alternate embodiments, the present invention may perform rotation modes that include elements and functionalities in addition to, or instead of, certain of the elements and functionalities discussed in conjunction with the FIG. 7 embodiment.

In the FIG. 7 embodiment, the (x, y) pixel coordinates of diagram 710 correspond to those (x, y) pixel coordinates shown in the FIG. 3 exemplary diagram 310 of memory cells 216. In the FIG. 7 embodiment, display 134 (FIG. 1) displays image data received from display controller 128 in a standard zero-degree rotation display sequence regardless of which rotation mode has been selected. With reference back to the FIG. 3 embodiment, in a 270-degree rotation mode, controller logic 220 provides pixels to display 134 in display lines that are arranged in a 270-degree rotation sequence of vertical columns from the FIG. 3 memory cells 216 starting with bottom left pixel (0, 7), and ending with the top right pixel (7, 0). The 270-degree rotation sequence therefore is essentially the reverse of the 90-degree rotation sequence discussed above in conjunction with FIG. 5.

In the FIG. 7 embodiment, controller logic 220 may provide a first display line of display pixels from memory cells D-A 216(d-a) to display 134 in the following sequence: (0, 7), (0, 6), (0, 5), (0, 4), (0, 3), (0, 2), (0, 1), 0, 0). Controller logic 220 may then provide a second display line of display pixels from memory cell D-A 216(d-a) to display 134 in the following sequence: (1, 7), (1, 6), (1, 5), (1, 4), (1, 3), (1, 2), (1, 1), (1, 0). Controller logic 220 may then continue to sequentially provide the remaining display lines of display pixels from memory cells 216 to display 134 in accordance with the same 270-degree rotation sequence shown in the FIG. 7 embodiment. In accordance with the present invention, since memory cells 216 are arranged in a parallel bank configuration, controller logic 220 may efficiently perform read operations during the 270-degree rotation mode by simultaneously reading four sequential pixels for the 270-degree rotation display lines from different sequential memory cells D-A 216(d-a) (see FIG. 2).

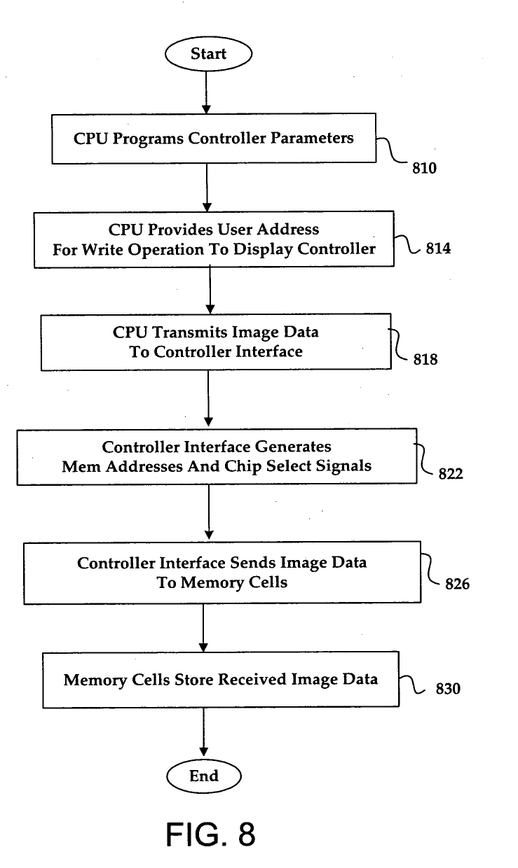

Referring now to FIG. 8, a flowchart of method steps for performing a write operation is shown, in accordance with one embodiment of the present invention. The FIG. 8 flowchart is presented for purposes of illustration, and in alternate embodiments, the present invention may utilize steps and sequences in addition to, or instead of, certain of the steps and sequences discussed in conjunction with the FIG. 8 embodiment.

In the FIG. 8 embodiment, in step 810, CPU 122 initially programs various controller parameters for display controller 128. For example, CPU 122 may program controller registers to specific a display line width and a color depth for display controller 128. In step 814, CPU 122 provides a user address for the write operation to a controller interface 212 of display controller 128. Then, in step 818, CPU 122 transmits image data for the write operation to the controller interface 212.

In step 822, controller interface 212 generates memory addresses and chip select signals for storing the received image data into a parallel bank of memory cells 216. In step 826, controller interface 212 sends the image data to the memory cells 216. Finally, in step 830, memory cells 216 store the received image data, and the FIG. 8 write operation may terminate.

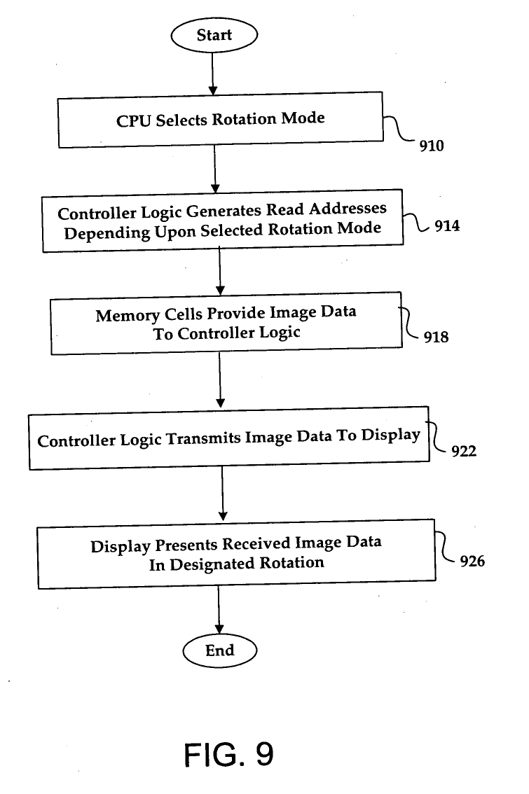

Referring now to FIG. 9, a flowchart of method steps for performing a read operation is shown, in accordance with one embodiment of the present invention. The FIG. 9 flowchart is presented for purposes of illustration, and in alternate embodiments, the present invention may utilize steps and sequences in addition to, or instead of, certain of the steps and sequences discussed in conjunction with the FIG. 9 embodiment.

In the FIG. 9 embodiment, in step 910, CPU 122 initially selects a rotation mode for displaying image data on display 134 (FIG. 1). In step 914, controller logic 220 of display controller 128 generates read addresses for memory cells 216 depending upon the selected rotation mode. Then, in step 918, memory cells 216 provide the image data to controller logic 220 in the correct selected rotation sequence. In step 922, controller logic 220 transmits the image data to display 134. Finally, in step 926, display 134 presents the received image data for viewing by a system user in the correct designated rotation. For at least the foregoing reasons, the present invention therefore provides an improved system and method efficiently supporting image rotation modes by utilizing a display controller.

The invention has been explained above with reference to certain preferred embodiments. Other embodiments will be apparent to those skilled in the art in light of this disclosure. For example, the present invention may be implemented using certain configurations and techniques other than those described in the embodiments above. Additionally, the present invention may effectively be used in conjunction with systems other than those described above as the preferred embodiments. Therefore, these and other variations upon the foregoing embodiments are intended to be covered by the present invention, which is limited only by the appended claims.

1. A system for supporting image rotation in an electronic device, comprising:
a controller interface that receives image data from an image data source, said controller interface responsively generating one or more memory addresses for storing said image data;
a memory array of memory cells configured for storing said image data in a distributed manner to facilitate read operations in one or more rotation modes; and
controller logic that generates read addresses to access a rotation sequence of pixels from said image data, said rotation sequence depending upon a selectable rotation mode parameter.

2. The system of claim 1 wherein said controller interface, said memory array, and said controller logic are embodied in a display controller that is implemented as an integrated circuit device.

3. The system of claim 2 wherein said display controller receives said image data from a central processing unit of an electronic device, said display controller providing said image data to a display coupled to said electronic device.

4. The system of claim 1 wherein said one or more rotation modes include a zero-degree rotation mode, a 90-degree rotation mode, a 180-degree rotation mode, and a 270-degree rotation mode.

5. The system of claim 1 wherein said memory array is configured as a parallel bank of said memory cells that facilitate said read operation by allowing said controller logic to simultaneously access multiple pixels from said memory cells to form said rotation sequence.

6. The system of claim 5 wherein a different adjacent display line of said image data is consecutively stored in each of said memory cells of said memory array.

7. The system of claim 1 wherein said image data source is implemented as a central processing unit that initiates a write operation to said memory array by providing a display-line width value and a color depth value to said controller interface.

8. The system of claim 1 wherein said image data source is implemented as a central processing unit that provides said image data and corresponding user addresses to said controller interface for performing a write operation to said memory array.

9. The system of claim 8 wherein said controller interface provides memory addresses and corresponding chip select signals to said memory cells based upon said user addresses.

10. The system of claim 9 wherein said controller interface provides said image data to said memory cells over corresponding write data lines, said memory cells responsively storing said image data at said memory addresses.

11. The system of claim 1 wherein a central processing unit programs said selectable rotation mode parameter to select a current rotation mode from among said one or more rotation modes.

12. The system of claim 11 wherein said selectable rotation mode parameter enables one of a zero-degree rotation mode, a 90-degree rotation mode, a 180-degree rotation mode, or a 270-degree rotation mode.

13. The system of claim 11 wherein said controller logic generates said read addresses during a read operation from said memory array to access said rotation sequence of said pixels from said image data.

14. The system of claim 13 wherein said rotation sequence is accessed by said controller logic as a zero-degree rotation sequence based upon a corresponding zero-degree rotation mode parameter.

15. The system of claim 13 wherein said rotation sequence is accessed by said controller logic as a 90-degree rotation sequence based upon a corresponding 90-degree rotation mode parameter.

16. The system of claim 13 wherein said rotation sequence is accessed by said controller logic as a 180-degree rotation sequence based upon a corresponding 180-degree rotation mode parameter.

17. The system of claim 13 wherein said rotation sequence is accessed by said controller logic as a 270-degree rotation sequence based upon a corresponding 270-degree rotation mode parameter.

18. The system of claim 1 wherein said memory array is configured as a parallel bank with four of said memory cells to facilitate said read operation by allowing said controller logic to simultaneously access multiple pixels from said parallel bank of said memory cells for forming said rotation sequence, each of said memory cells of said memory array storing a different consecutive adjacent display line of said image data.

19. The system of claim 1 wherein said controller logic provides said rotation sequence of said pixels from said image to a display device.

20. The system of claim 19 wherein said display device presents said rotation sequence of said pixels for viewing in a rotation alignment specified by said selectable rotation parameter.

21. A method for supporting image rotation in an electronic device, comprising:
receiving image data from an image data source by utilizing a controller interface that responsively generates one or more memory addresses for storing said image data;
configuring a memory array of memory cells for storing said image data in a distributed manner to facilitate read operations in one or more rotation modes; and
generating read addresses with controller logic to access a rotation sequence of pixels from said image data, said rotation sequence depending upon a selectable rotation mode parameter.

22. The method of claim 21 wherein said controller interface, said memory array, and said controller logic are embodied in a display controller that is implemented as an integrated circuit device.

23. The method of claim 22 wherein said display controller receives said image data from a central processing unit of an electronic device, said display controller providing said image data to a display coupled to said electronic device.

24. The method of claim 21 wherein said one or more rotation modes include a zero-degree rotation mode, a 90-degree rotation mode, a 180-degree rotation mode, and a 270-degree rotation mode.

25. The method of claim 21 wherein said memory array is configured as a parallel bank of said memory cells that facilitate said read operation by allowing said controller logic to simultaneously access multiple pixels from said memory cells to form said rotation sequence.

26. The method of claim 25 wherein a different adjacent display line of said image data is consecutively stored in each of said memory cells of said memory array.

27. The method of claim 21 wherein said image data source is implemented as a central processing unit that initiates a write operation to said memory array by providing a display-line width value and a color depth value to said controller interface.

28. The method of claim 21 wherein said image data source is implemented as a central processing unit that provides said image data and corresponding user addresses to said controller interface for performing a write operation to said memory array.

29. The method of claim 28 wherein said controller interface provides memory addresses and corresponding chip select signals to said memory cells based upon said user addresses.

30. The method of claim 29 wherein said controller interface provides said image data to said memory cells over corresponding write data lines, said memory cells responsively storing said image data at said memory addresses.

31. The method of claim 21 wherein a central processing unit programs said selectable rotation mode parameter to select a current rotation mode from among said one or more rotation modes.

32. The method of claim 31 wherein said selectable rotation mode parameter enables one of a zero-degree rotation mode, a 90-degree rotation mode, a 180-degree rotation mode, or a 270-degree rotation mode.

33. The method of claim 31 wherein said controller logic generates said read addresses during a read operation from said memory array to access said rotation sequence of said pixels from said image data.

34. The method of claim 33 wherein said rotation sequence is accessed by said controller logic as a zero-degree rotation sequence based upon a corresponding zero-degree rotation mode parameter.

35. The method of claim 33 wherein said rotation sequence is accessed by said controller logic as a 90-degree rotation sequence based upon a corresponding 90-degree rotation mode parameter.

36. The method of claim 33 wherein said rotation sequence is accessed by said controller logic as a 180-degree rotation sequence based upon a corresponding 180-degree rotation mode parameter.

37. The method of claim 33 wherein said rotation sequence is accessed by said controller logic as a 270-degree rotation sequence based upon a corresponding 270-degree rotation mode parameter.

38. The method of claim 21 wherein said memory array is configured as a parallel bank with four of said memory cells to facilitate said read operation by allowing said controller logic to simultaneously access multiple pixels from said parallel bank of said memory cells for forming said rotation sequence, each of said memory cells of said memory array storing a different consecutive adjacent display line of said image data.

39. The method of claim 21 wherein said controller logic provides said rotation sequence of said pixels from said image to a display device.

40. The method of claim 39 wherein said display device presents said rotation sequence of said pixels for viewing in a rotation alignment specified by said selectable rotation parameter.

41. A system for supporting image rotation in an electronic device, comprising:
means for receiving image data from an image data source, said means for receiving responsively generating one or more memory addresses for storing said image data;
means for storing said image data in a distributed manner to facilitate read operations in one or more rotation modes; and
means for generating read addresses to access a rotation sequence of pixels from said image data, said rotation sequence depending upon a selectable rotation mode parameter.

42. A system for supporting image rotation in an electronic device, comprising:
a controller interface that generates one or more memory addresses for storing image data;
memory cells that store said image data in a distributed manner to facilitate a rotation mode; and
controller logic that accesses a pixel sequence from said image data depending upon said rotation mode.
